(19) United States
(12) Patent Application Publication
(10) Pub. No.: US 2026/0083624 A1
(43) Pub. Date: Mar. 26, 2026

(54) NECK MASSAGER

(71) Applicant: GUANGDONG MOFA E-COMMERCE CO., LTD., Foshan, Guangdong (CN)

(72) Inventors: Guannan XUE, Foshan, Guangdong (CN); Zhongming YANG, Foshan, Guangdong (CN); Yongbiao XU, Foshan, Guangdong (CN)

(21) Appl. No.: 18/274,596

(22) PCT Filed: Apr. 10, 2023
(86) PCT No.: PCT/CN2023/087353

§ 371 Date: Dec. 11, 2025

(30) Foreign Application Priority Data
Feb. 14, 2023 (CN) 202310121240.6
Feb. 14, 2023 (CN) 202320226753.9

(51) Int. Cl. A61H 15/00

(52) U.S. Cl. CPC A61H 15/0078; A61H 2015/0042; A61H 2201/1611; A61H 2201/1669; A61H 2201/1676; A61H 2205/04

(57) ABSTRACT

The present application relates to the technical field of massaging instruments, and more particularly to a neck massager, which includes a main shell a massage assembly, a casing and a first pressing member; the massage assembly is mounted in the assembly chamber of the main shell, at least one end of the casing is provided with an opening, the main shell is inserted into the casing from the opening, the end of the main shell corresponding to the opening is provided with an assembly position, and a circumferential edge of the opening is gathered to the assembly position; the first pressing member is mounted at the main shell and the circumferential edge of the opening is clamped between the first pressing member and the assembly position.

### CROSS REFERENCE TO RELATED APPLICATION

This application is a National Stage Appl. of International Patent Application No. PCT/CN2023/087353 with an international filing date of Apr. 10, 2023, and claims priorities of a Chinese Patent Application with Application No. 202310121240.6, filed on Feb. 14, 2023; and a Chinese Patent Application with Application No. 202320226753.9, filed on Feb. 14, 2023, the contents each of which are incorporated herein by reference.

### TECHNICAL FIELD

The present application relates to the technical field of massaging instruments, and more particularly to a neck massager.

### BACKGROUND

At present, the main components of the neck massager on the market include a main shell and a massage assembly, the massage assembly is assembled on the main shell for massaging the neck of the user.

On the neck massager, in order to avoid direct contact of the massage head of the massage assembly with the neck skin of the user and wear the neck skin, the neck massager is designed with a casing made of a soft fabric to cover the main shell and the massage assembly. In this way, when the user massages the neck using the neck massager, the massage head of the massage assembly indirectly contacts the neck of the user by the fabric for massaging.

However, the existing casing either encloses the main shell and the massage assembly in a cylindric shape after the main shell and the massage assembly are assembled together through zipper connection, and such casing is prone to be wrinkled relative to the main shell or even expose the massage head during the movement of the massage head. The wrinkled casing or exposed massage head will cause discomfort to users. In addition, the zipper after the casing is misplaced will cause discomfort to users, and the exposed zipper is not beautiful, which will affect the use experience of the user, and adding of a zipper will increase the corresponding cost. Alternatively, after the casing wraps around the massage assembly, the fabric edges of the casing need to be fixed on the main shell by gluing, laminating and other ways, so that the assembly process is complicated and thereby affects the production efficiency.

### SUMMARY

An object of an embodiment of the present application is to provide a neck massager, including but not limited to solve the problem that the casing in the existing neck massager has a complicated assembly process and the casing is easy to misplace relative to the main shell during the movement of the massage head.

The technical solution adopted by the embodiment of the present application is as following:

A neck massager is provided, and the neck massager includes:

a main shell, with a contour shape being arranged to fit with a neck, wherein main shell is provided with an assembly chamber;

a massage assembly, mounted in the assembly chamber and configured for massaging the neck;

a casing, and at least one end of the casing is provided with an opening, the main shell is inserted into the casing from the opening, and an end of the main shell corresponding to the opening is provide with an assembly position, and a circumferential edge of the opening is gathered to the assembly position; and

a first pressing member, mounted at the main shell, and the circumferential edge of the opening is clamped between the first pressing member and the assembly position.

In some embodiments, two ends of the casing are respectively provided with the opening, and two ends of the main shell are respectively provided with the assembly position; the neck massager further includes a second pressing member connected to the other end of the main shell, the circumferential edge of one of the openings is clamped between the first pressing member and one of the assembly positions, and the circumferential edge of the other one of the openings is clamped between the second pressing member and the other one of the assembly positions.

In some embodiments, an end of the casing is provided with the opening, the other end of the casing is arranged to be a closed end, and two ends of the main shell are respectively provided with the assembly position; the neck massager further includes a second pressing member connected to the other end of the main shell, the circumferential edge of the opening is clamped between the first pressing member and one of the assembly positions, and the closed end is clamped between the second pressing member and the other one of the assembly positions.

In some embodiments, the neck massager further includes two clamping arm assemblies, one of the two clamping arm assemblies is connected to the first pressing member, the other one of the two clamping arm assemblies is connected to the second pressing member, and the two clamping arm assemblies are configured for jointly clamping on the neck.

In some embodiments, each of the two clamping arm assemblies includes a mounting structure and a swinging arm structure, one end of the swinging arm structure is rotated and mounted at the end of the main shell through the mounting structure, and the mounting structure provides a clamping force to the swinging arm structure such that the other end of the swinging arm structure clamps the neck.

In some embodiments, the mounting structure includes a mounting seat, a torsion spring and a pin shaft, and the mounting seat is fixed at the end of the main shell, one end of the swinging arm structure is rotationally connected to the mounting seat through the pin shaft, the torsion spring is sleeved on the pin shaft, one end of the torsion spring is abutted against the mounting seat, and the other end of the torsion spring is abutted against one end of the swinging arm structure, so as to provide the clamping force.

In some embodiments, the swinging arm structure includes an arm rod and a supporting portion, a first end of the arm rod is connected to the mounting structure, and the supporting portion is rotated and mounted at a second end of the arm rod.

In some embodiments, the swinging arm structure further includes a ball member, the ball member is provided with rotatable balls, the ball member is mounted on the supporting portion; a side of the second end of the arm rod facing the supporting portion is provided with a rolling rail, the balls of the ball member are arranged on the rolling rail and rotate along the rolling rail.

In some embodiments, the rolling rail is formed with a plurality of ball sockets arranged at intervals along a groove track path, and the balls of the ball member are capable of inlaying and positioning in the ball sockets.

In some embodiments, each of the two clamping arm assemblies further includes a supporting casing, the supporting portion comprises a first shell body and a second shell body, the supporting casing wraps around the second shell body, the first shell body covers on the second shell body, the first shell body and the second shell body are configured to clamp and fix an edge of a casing opening of the supporting casing, and the first shell body is rotated and mounted at the second end of the arm rod.

In some embodiments, a contour shape of the casing is matched with the contour shape of the main shell, the casing comprises a first elastic fabric and a second elastic fabric, an edge of the first elastic fabric is connected to an edge of the second elastic fabric, and an elasticity of the first elastic fabric is greater than that of the second elastic fabric.

In some embodiments, a width of the second elastic fabric is arranged to increase from a middle to two ends.

In some embodiments, at least a portion of the first elastic fabric corresponds to the massage assembly and is attached to the neck.

The present application has at least the following beneficial effects:

When the neck massager provided in the present application is assembled and produced, the main shell and the massage assembly are assembled into the main structure of the neck massager, and the main shell and the massage assembly are wrapped by the casing. Since the casing is provided with an opening at least at one end, the main shell and the massage assembly that have been assembled together only need to be placed into the casing through the opening during assembly. The contour shape of the casing can be deformed to fit the contour shape of the main shell, and then the opening is sealed. Accordingly, the end of the main shell corresponding to the opening is provided with an assembly position, the circumferential edge of the opening is gathered in the assembly position, and then the first pressing member is mounted on the end of the main shell corresponding to the opening. In this way, the circumferential edge of the opening is clamped and fixed between the first pressing member and the assembly position, and then the assembly and production work of the neck massager is completed. Due that only the first pressing member and the corresponding assembly position are used in the assembly and production work, the sealing assembly of the opening of the casing can be quickly completed, which simplifies the assembly and production process and greatly improves the assembly and production efficiency. During massaging the neck of the user by the massage assembly, the casing can always be in a tight state relative to the main shell, the probability of the casing being stirred and folded together by the massage assembly can be reduced or even avoided. The tight and smooth surface of the casing contacts the neck skin of the user, making the user always feel comfortable during the massage process, and enhancing the user experience.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a first schematic view of a neck massager after the assembly is completed in an embodiment of the present application;

FIG. 2 is a second schematic view of the neck massager shown in FIG. 1 after the assembly is completed;

FIG. 3 is a third schematic view of the neck massager shown in FIG. 1 after the assembly is completed, and the casing and two supporting casings in FIG. 3 are removed;

FIG. 4 is a cross sectional view along a A-A direction in FIG. 3;

FIG. 5 is a first explosive view of the neck massager shown in FIG. 1;

FIG. 6 is a second explosive view of the neck massager shown in FIG. 1;

FIG. 7 is an explosive view of a casing, a main shell, a massage assembly, and a reinforcing plate in the neck massager shown in FIG. 1;

FIG. 8 is a structural schematic view of a first rod shell of a clamping arm assembly in the neck massager shown in FIG. 1;

FIG. 9 is a structural schematic view of the first/second pressing member in the neck massager shown in FIG. 1;

FIG. 10 is a first schematic view of another neck massager after the assembly is completed in an embodiment of the present application;

FIG. 11 is a second schematic view of the neck massager shown in FIG. 10 after the assembly is completed;

FIG. 12 is a first explosive view of the neck massager shown in FIG. 10;

FIG. 13 is a second explosive view of the neck massager shown in FIG. 10; and

FIG. 14 is an explosive view of a casing, a main shell, a massage assembly, and a reinforcing plate in the neck massager shown in FIG. 10.

In the drawings, the reference numerals are listed:

10—main shell; 11—assembly chamber; 12—assembly position; 13—battery compartment cover; 101—main body; 102—shell cover;

20—massage assembly; 21—motor; 22—massage head; 23—battery;

30—clamping arm assembly; 31—mounting structure; 311—mounting seat; 312—torsion spring; 313—pin shaft; 32—swing arm structure; 321—arm rod; 3211—rolling rail; 3212—ball socket; 3213—first rod shell; 3214—second rod shell; 3215—convex column; 322—supporting portion; 3221—first shell body; 3222—second shell body; 3223—adapter plate; 3224—supporting block; 3225—accommodating groove; 323—ball assembly; 33—supporting casing; 331—casing opening;

40—casing; 41—opening; 42—closed end; 401—first elastic fabric; 402—second elastic fabric;

51—first pressing member; 52—second pressing member; 501—protrusion; 502—buckle hook; 503—positioning column; and

61—reinforcing plate; 62—connecting plate; 63—circuit board module.

### DETAILED DESCRIPTION OF EMBODIMENTS

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component. Terms such as “up”, “down”, “left”, “right” and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application. For those skilled in the art, the specific meanings of the aforementioned terms in the present application can be interpreted according to specific conditions. In addition, terms “the first” and “the second” are only used in describe purposes, and should not be considered as indicating or implying any relative importance, or impliedly indicating the number of indicated technical features, and “a plurality of” means two or more, unless there is additional explicit and specific limitation.

In order to illustrate the technical solutions provided in the present application, the following are detailed in conjunction with specific drawings and embodiments.

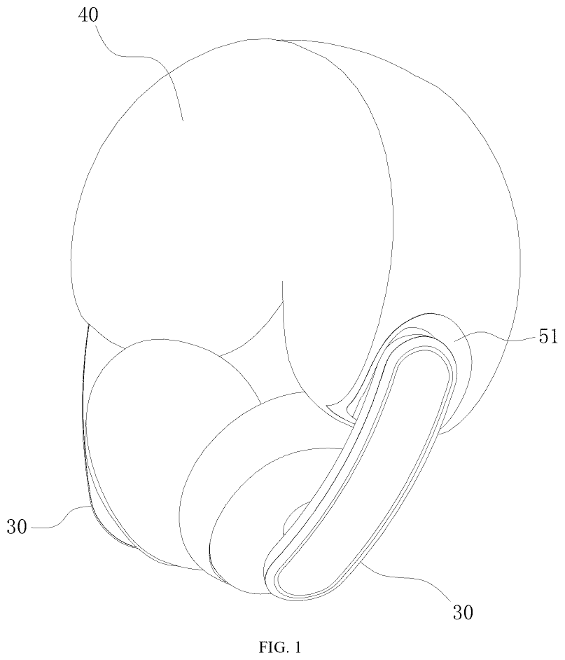

FIGS. 1 to 9 show structural views of one of the neck massagers of the embodiments of the present application.

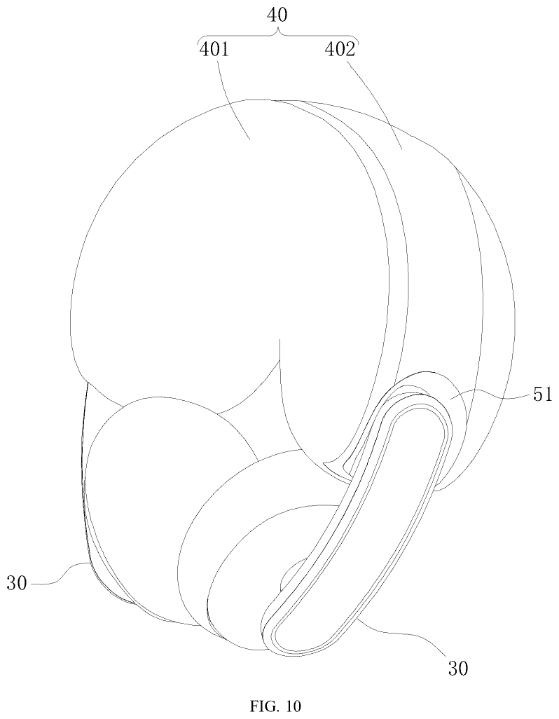

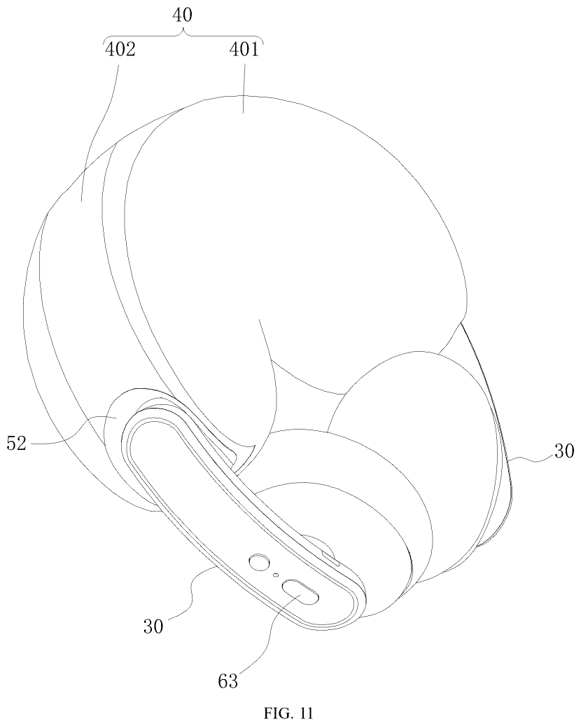

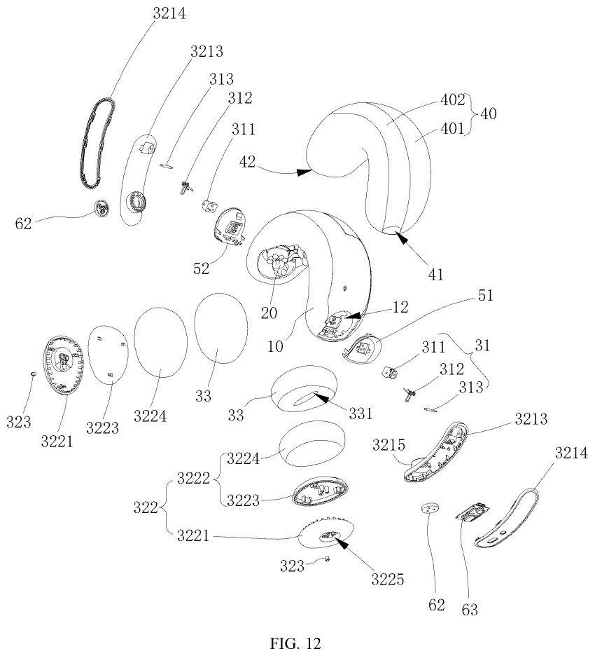

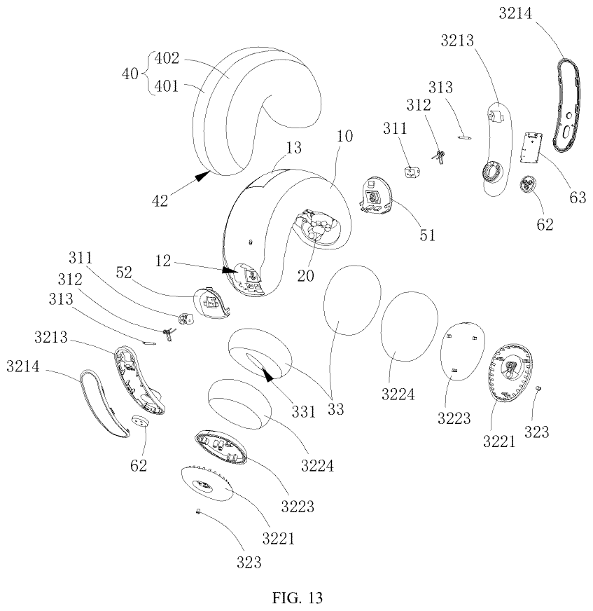

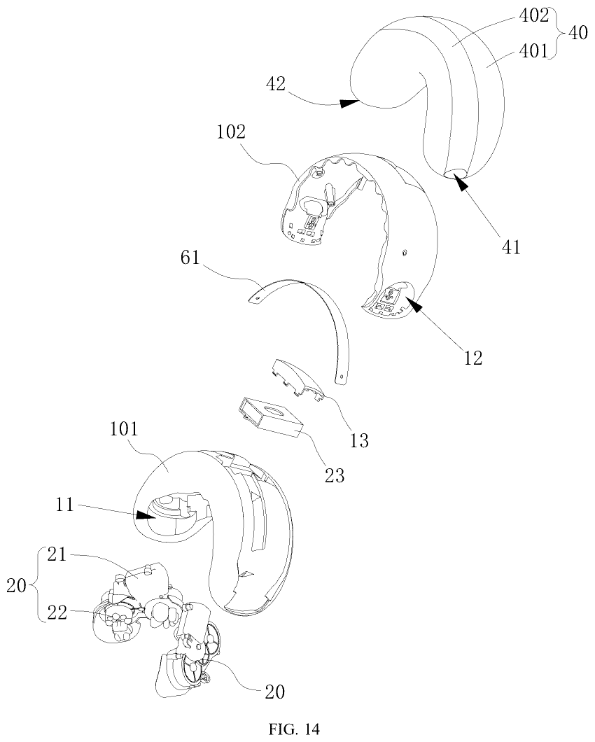

FIGS. 10 to 14 show a schematic views of another neck massager of the embodiments of the present application.

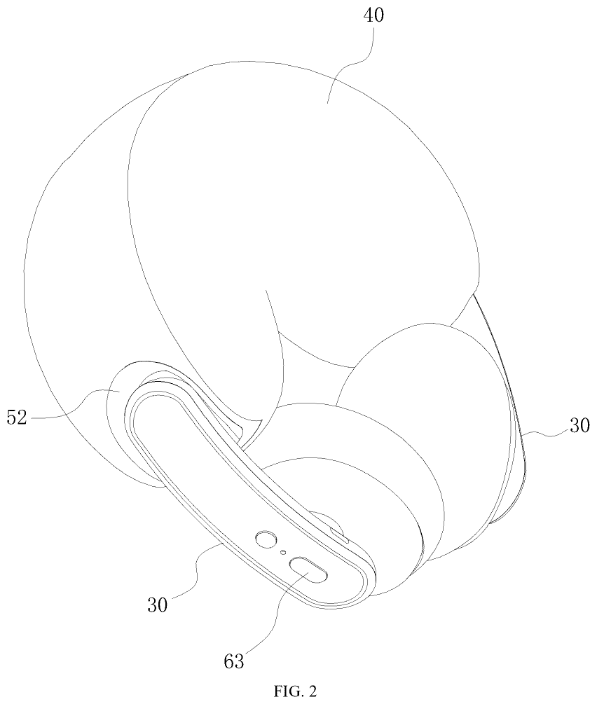

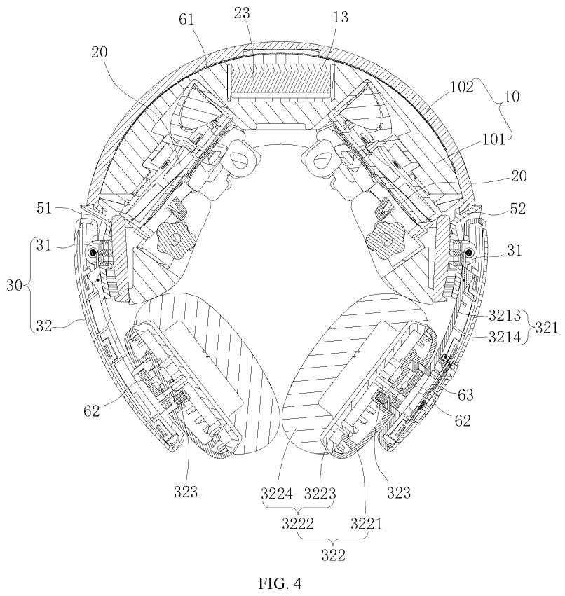

As shown in FIG. 1, FIG. 2, FIG. 4 to FIG. 7, a neck massager provided in the embodiment of the present application includes a main shell 10, a massage assembly 20, a casing 40 and a first pressing member 51. The contour shape of the main shell 10 is arranged to be fit the neck, so that the neck massager can be stably worn on the neck of the user, and the contour shape of the main shell of the neck massager adopts the ergonomic design principle that fits the human neck, such that the user more comfortable to wear the neck massager. The main shell 10 is provided with a assembly chamber 11, and the massage assembly 20 is mounted in the assembly chamber 11. When the user wears the neck massager and activates the massage assembly 20, the massage assembly 20 can be used to massage the neck of the user. Further, the casing 40 is made of a soft elastic fabric, so that the contour shape deformation of the casing 40 can be adapted to the contour shape of the main shell 10. At least one end of the casing 40 is provided with an opening 41, and the main shell 10 is inserted into the casing 40 from the opening 41, so that the casing 40 wraps the main shell 10 and the massage assembly 20. In addition, the end of the main shell 10 corresponding to the opening 41 is provided with an assembly position 12, and the circumferential edge of the opening 41 of the casing 40 is gathered at the assembly position 12, and then the first pressing member 51 is mounted on the end of the main shell 10 corresponding to the opening 41 through a connecting member (not shown), such that the circumferential edge of the opening 41 of the casing 40 is clamped and fixed between the first pressing member 51 and the assembly position 12.

When the neck massager provided in the present application is assembled and produced, the main shell 10 and the massage assembly 20 are assembled into the main structure of the neck massager, and the main shell 10 and the massage assembly 20 are wrapped by the casing 40. Since the casing 40 is provided with an opening 41 at least at one end, the main shell 10 and the massage assembly 20 that have been assembled together only need to be placed into the casing 40 through the opening 41 during assembly. The contour shape of the casing 40 can be deformed to fit the contour shape of the main shell 10, and then the opening 41 is sealed. Accordingly, the end of the main shell 10 corresponding to the opening 41 is provided with an assembly position 12, the circumferential edge of the opening 41 is gathered in the assembly position 12, and then the first pressing member 51 is mounted on the end of the main shell 10 corresponding to the opening 41. In this way, the circumferential edge of the opening 41 is clamped and fixed between the first pressing member 51 and the assembly position 12, and then the assembly and production work of the neck massager is completed. Due that only the first pressing member 51 and the corresponding assembly position 12 are used in the assembly and production work, the sealing assembly of the opening of the casing 40 can be quickly completed, which simplifies the assembly and production process and greatly improves the assembly and production efficiency. During massaging the neck of the user by the massage assembly 20, the casing 40 can always be in a tight state relative to the main shell 10, the probability of the casing 40 being stirred and folded together by the massage assembly can be reduced or even avoided. The tight and smooth surface of the casing 40 contacts the neck skin of the user, making the user always feel comfortable during the massage process, and enhancing the user experience.

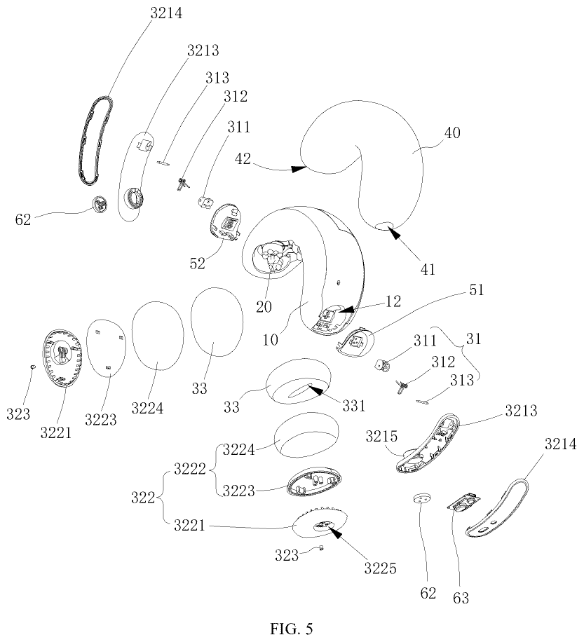

In some embodiments, one end of the casing 40 is provided with the opening 41 and the other end is provided with a closed end 42. The main shell 10 and the massage assembly 20 that have been assembled together are placed into the casing 40 from the opening 41 until the end of the main shell 10 touches and tenses the closed end 42, and then the circumferential edge of the opening 41 is gathered within the assembly position 12. Then the first pressing member 51 is mounted on the end of the main shell 10 corresponding to the opening 41, so that the circumferential edge of the opening 41 is clamped and fixed between the first pressing member 51 and the assembly position 12. Further, in order to further improve the assembly and production efficiency, as shown in FIGS. 5 to 7, both ends of the main shell 10 are provided with the assembly positions 12, and as shown in FIG. 1, FIGS. 4 to 6, and FIG. 9, the neck massager in the present embodiment also includes a second pressing member 52. The second pressing member 52 is mounted on the end of the main shell 10 corresponding to the closed end 42, such that the closed end 42 is clamped and fixed between the second pressing member 52 and the corresponding assembly position 12. In this way, the two ends of the casing 40 are respectively fixed on the two ends of the main shell 10 by the first pressing member 51 and the second pressing member 52, so that the casing 40 is tight and fit to the surface of the main shell 10, so as to ensure that the casing 40 will not be stirred and folded together during massaging the neck of the user by the massage assembly 20. The tight and smooth surface of the casing 40 contacts the neck skin of the user, making the user always feel comfortable during the massage process, and the use experience of the user is better improved.

In some embodiments, both ends of the casing 40 are provided with the openings 41. In this case, the worker does not need to find which end of the main shell 10 corresponds to the opening 41. The worker may insert either end of the integrated module of the main shell 10 and the massage assembly 20 that has been assembled into the casing 40 through any one of the openings 41.

The neck massager in the embodiment adopts a design in which both ends of the casing 40 are provided with the openings 41.

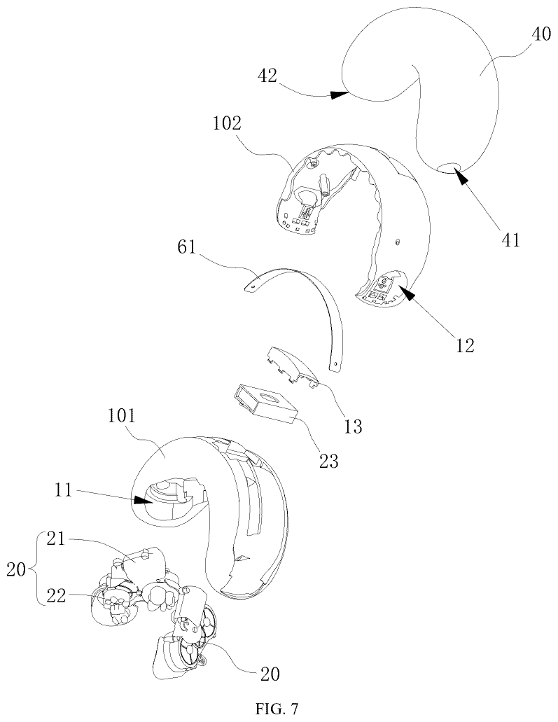

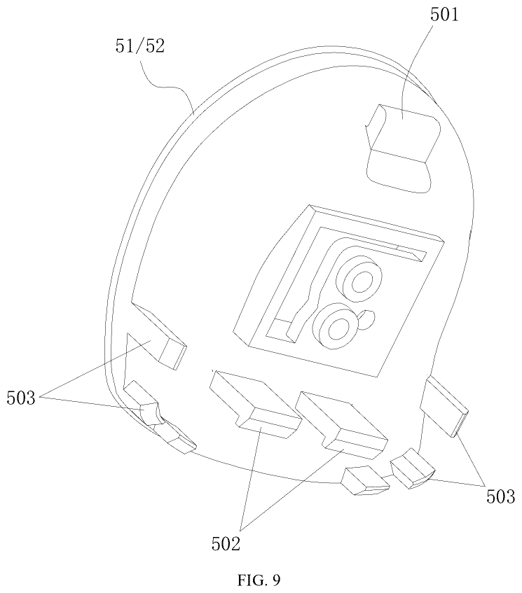

As shown in FIGS. 5 and 7, both ends of the main shell 10 are provided with the assembly positions 12, and, as shown in FIG. 1, FIG. 4 to FIG. 6, and FIG. 9, the neck massager in the embodiment also includes a second pressing member 52. Thus, the circumferential edges of the two openings 41 are respectively gathered at the corresponding assembly position 12, and then the first pressing member 51 and the second pressing member 52 are respectively mounted at both ends of the main shell 10, so that the circumferential edge of one opening 41 is clamped and fixed between the first pressing member 51 and one assembly position 12, and the circumferential edge of the other opening 41 is clamped and fixed between the second pressing member 52 and an other assembly position 12. In this way, the two ends of the casing 40 are respectively fixed on the two ends of the main shell 10 by the first pressing member 51 and the second pressing member 52, so that the casing 40 is tight and fit to the surface of the main shell 10, so as to ensure that the casing 40 will not be stirred and folded together during massaging the neck of the user by the massage assembly 20. The tight and smooth surface of the casing 40 contacts the neck skin of the user, making the user always feel comfortable during the massage process, and the use experience of the user is better improved.

In fact, the first pressing member 51 and the second pressing member 52 are two structural parts with exactly the same structure, shape and size.

The neck massager in the embodiment further includes two clamping arm assemblies 30, which are respectively connected to the first pressing member 51 and the second pressing member 52, so that the assembly process of the two clamping arm assemblies 30 corresponding to both ends of the main shell 10 is the same assembly process. When the user wears the neck massager, the two clamping arm assemblies 30 are used to jointly clamp the left and right sides of the neck of the user, so that the two clamping arm assemblies 30 and the main shell 10 cooperate with each other, so that the whole neck massager can be placed on the neck of the user more stably. The neck massager can be kept stable and not detached from the neck of the user even during the process of massaging the neck of the user by the massage assembly 20.

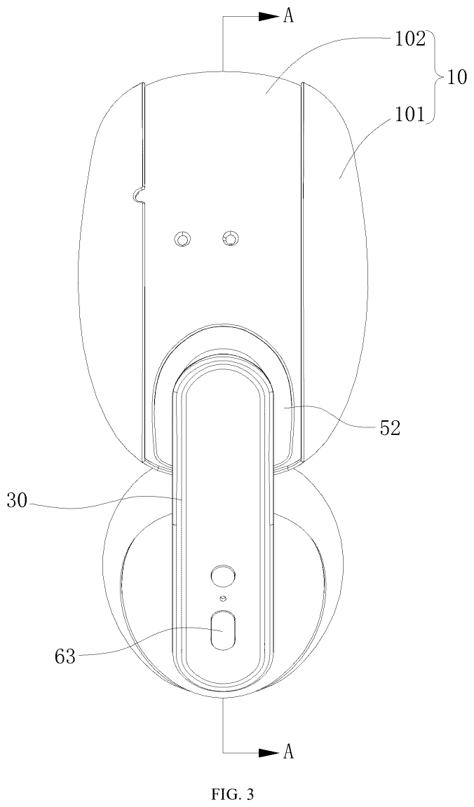

As shown in FIG. 3 and FIG. 4 to FIG. 7, the main shell 10 includes a main body 101 and a shell cover 102. The main body 101 and the shell cover 102 cover each other, and the shell cover 102 is fixed on the main body 101 by screws. The assembly chamber 11 is arranged on the side of the main body 101 away from shell cover 102, and the side of the main body 101 facing the shell cover 102 is provided with a battery compartment for mounting a battery 23. After assembling the battery 23 into the battery compartment, as shown in FIG. 7, the battery compartment cover 13 is closed on the opening of the battery compartment and connected to the top of the battery 23, so as to fix the battery 23 in the battery compartment. As shown in FIG. 7, the massage assembly 20 includes a motor 21 and a massage head 22, the motor 21 drives the massage head 22 to rotate to massage the neck of the user. The battery compartment is communicated to the assembly chamber 11, and after the massage module 20 is assembled into the assembly chamber 11, the wire of the motor 21 is extended to the battery 23 for electrical connection. In order to further improve the structural strength of the main shell 10, a reinforcing plate 61 is arranged, as shown in FIG. 4 and FIG. 7, the reinforcing plate 61 is arranged between the main body 101 and the shell cover 102, and the two ends of the reinforcing plate 61 are locked on the main body 101 by screws. The main body 101 and the shell cover 102 cover each other to form a gap for laying wires. In addition, two assembly positions 12 are respectively arranged at both ends of the shell cover 102, specifically, two assembly positions 12 are assembly grooves arranged at both ends of the shell cover 102, and the ends of the two clamping arm assemblies 30 are accommodated in the assembly grooves without protruding, such that the appearance of the neck massager is more beautiful.

As shown in FIG. 9, the first pressing member 51 and the second pressing member 52 are provided with a protrusion 501, a buckle hook 502 and a positioning column 503. When the first pressing member 51/the second pressing member 52 is assembled into the corresponding assembly position 12, the protrusion 501 is first snap-fitted to an engagement groove on the groove wall of the assembly position 12, and then the positioning column 503 is correspondingly inserted into a positioning hole on a groove bottom of the assembly position 12, and the buckle hook 502 hooks the groove bottom of the assembly position 12, thus the first pressing member 51/the second pressing member 52 and the end of the main shell 10 are initially positioned and engaged.

As shown in FIG. 4, each of the clamping arm assemblies 30 of the neck massager of the present application includes a mounting structure 31 and a swinging arm structure 32.

In some embodiments, the swing arm structure 32 can be molded into a swing arm rod using a material with elastic bending ability, and one end of the swing arm rod is fixed to the end of the main shell 10 by the mounting structure 31. Thus, when the user wears the neck massager, the user expands the two swinging arms and places them on the neck, then releases the swinging arms, and the swinging arms recover based on the elastic property and clamp the neck of the user.

Alternatively, the swinging arm structure 32 provides a clamping force to the swinging arm structure 32 by the mounting structure 31. In the present embodiment, one end of the swinging arm structure 32 is rotated to the end of the main shell 10 by the mounting structure 31, and the mounting structure 31 provides the clamping force to the swinging arm structure 32 that causes the other end of swinging arm structure 32 to clamp the neck. As shown in FIG. 4 to FIG. 6, the mounting structure 31 includes a mounting seat 311, a torsion spring 312 and a pin shaft 313. The mounting seat 311 is fixed at the end of the main shell 10, one end of the swinging arm structure 32 is rotationally connected to the mounting seat 311 through the pin shaft 313, and the torsion spring 312 is sleeved on the pin shaft 313, and one end of the torsion spring 312 is connected to the mounting seat 311 and the other end of the torsion spring 312 is connected to the end of the swing arm structure 32 to provide the clamping force. The mounting seat 311 is mounted by means of a connecting member, the connecting member is a screw (or other part capable of achieving locking connection, such as a dowel for interference assembly), the screw is successively penetrated through the mounting seat 311, the first pressing member 51, the second pressing member 52, and the groove bottom of the assembly position 12, and then locked on the main body 101. The first pressing member 51/ the second pressing member 52 is clamped and fixed between the mounting seat 311 and the assembly position 12.

In the present embodiment, as shown in FIG. 4 to FIG. 6, the swinging arm structure 32 comprises an arm rod 321 and a supporting portion 322, a first end of the arm rod 321 is connected to the mounting structure 31, and the supporting portion 322 is rotated and mounted at the second end of the arm rod 321. When the user is wearing the neck massager, the supporting portion 322 can be rotated to adjust the adaptability of the contact surface and the neck surface of the supporting portion 322, so as to find the most comfortable state between the supporting portion 322 and the neck. The length of the swing arm structure 32 is extended by arranging the arm rod 321, so that the main shell 10 and two clamping arm assemblies 30 are basically combined to form a circle, that is, when the user is wearing the neck massager, the neck massager is basically around the neck of the user, so that the neck massager can be stably placed on the neck of the user for massaging the neck. In addition, the second end of the arm rod 321 away from the end of the main shell 10 is provided with the supporting portion 322 to support the neck of the user. As the contact surface of the supporting portion 322 in contact with the neck of the user is larger than that of the contact surface of the arm rod 321 in direct contact with the neck of the user, the pressure applied on the neck of the user surface is smaller. Even if the user wears the neck massager for a long time, it will not be squeezed by the supporting portion 322 and the neck will not feel pain and discomfort.

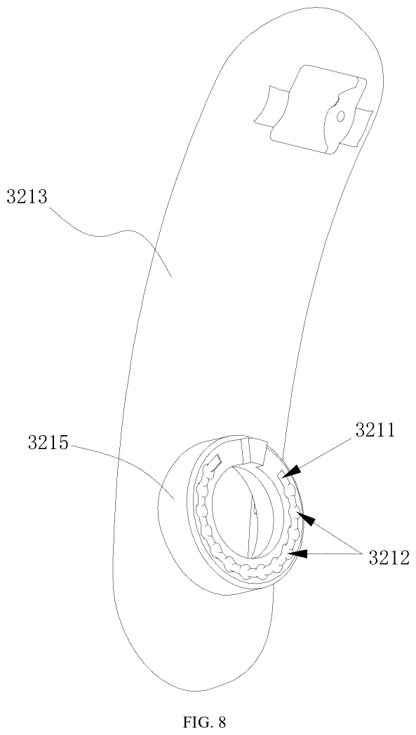

In order to enable stably, rapidly and accurately adjust the supporting portion 322 to rotate, as shown in FIG. 4 to FIG. 6 and FIG. 8, the swing arm structure 32 of the neck massager further includes a ball member 323, the ball member 323 is provided with rotatable balls and the ball member 323 is mounted on the supporting portion 322. The second end of the arm rod 321 is provided with a rolling rail 3211 towards the side of the supporting portion 322, and the balls of the ball member 323 is arranged in the rolling rail 3211 to roll along the rolling rail 3211. The rotation process of the supporting portion 322 relative to the end of the arm rod 321 is guided by the matching between the rolling rail 3211 and the balls of the ball member 323. Moreover, as shown in FIG. 8, the rolling rail 3211 is formed with a plurality of ball sockets 3212 at intervals along the groove track path, and the balls of the ball member are capable of inlaying and positioning in the ball sockets 3212. Preferably, the spacing between any two adjacent ball sockets 3212 is equal, that is, when the balls of ball member 323 rotates between any adjacent two ball sockets 3212, the rotation angle of the supporting portion 322 relative to the arm rod 321 is equal. Moreover, when the balls of the ball member 323 is inlaid into any ball socket 3212, the state of the supporting portion 322 relative to the arm rod 321 can also be maintained.

In the neck massager of the present embodiment, each of the clamping arm assemblies 30 further includes a supporting casing 33, so that the supporting portion 322 is in contact with the neck through the supporting casing 33, and the supporting casing 33 is also made of a soft elastic fabric. Specifically, as shown in FIG. 4 to FIG. 6, the supporting portion 322 includes a first shell body 3221 and a second shell body 3222; the supporting casing 33 wraps around the second shell body 3222, the first shell body 3221 covers the second shell body 3222, the first shell body 3221 and the second shell body 3222 clamp and fix the edge of the casing opening 331 of the supporting casing 33, and the first shell body 3221 is rotated and mounted at the second end of the arm rod 321. As shown in FIG. 4 to FIG. 6, the second shell body 3222 includes an adapter plate 3223 and a supporting block 3224. The adapter plate 3223 is connected to the first shell body 3221, and the supporting block 3224 is fixed on the side of the adapter plate 3223 away from the first shell body 3221, and the contact surface of the supporting block 3224 is polished, such that the contact surface has a smooth arc type, which makes more comfortable on the neck of the user.

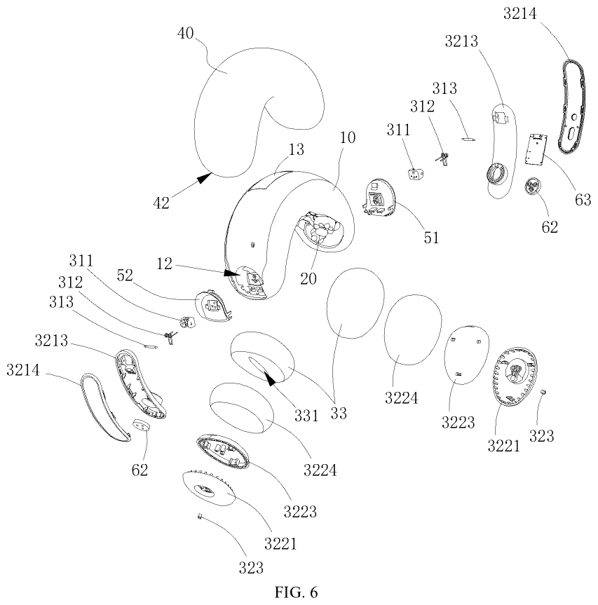

Specifically, as shown in FIG. 5 and FIG. 6, the arm rod 321 includes a first rod shell 3213 and a second rod shell 3214, the first rod shell 3213 and the second rod shell 3214 are mutually covered and formed into a complete arm rod 321 with a slightly curved strip shape, and after the first rod shell 3213 and the second rod shell 3214 are covered, and an inter space is formed between the first rod shell 3213 and the second rod shell 3214. The inner space is used to mount the circuit board module 63, the circuit board module 63 is provided with a power switch, a regulating switch for adjusting the speed of the motor 21, and other functional switches. During assembly, the mounting seat 311 is first locked to the main body 101, and then the torsion spring 312 is mounted on the mounting seat 311 through the pin shaft 313, and an end of the first rod shell 3213 is then hinged through the pin shaft 313, such that the torsion spring 312 generates a pretension force between an end of the mounting seat 311 and the first rod shell 3213, which causes the first rod shell 3213 to turn inward towards the main shell 10.

Further, as shown in FIG. 8, the other end of the first rod shell 3213 is provided with a convex column 3215, and the convex column 3215 is hollow. Accordingly, the first shell body 3221 is provided with an accommodating groove 3225. The convex column 3215 is inserted into the accommodating groove 3225, and the connecting plate 62 is locked by a screw through a hollow hole of the convex column 3215. Then the connecting plate 62 blocks the other end of the first rod shell 3213 and cannot be detached. At this time, the first shell body 3221 can rotate relative to the axis of the convex column 3215. Then the circuit board module 63 is mounted and fixed on the first rod shell 3213. More specifically, the rolling rail 3211 and the plurality of ball sockets 3212 are arranged on the end surface of the convex column 3215, and correspondingly, the ball member 323 is mounted on the groove bottom of the accommodating groove 3225.

Finally, the second rod shell 3214 is covered to the first rod shell 3213, and the power switch, the regulating switch for adjusting the speed of the motor 21, and other functional switches are passed through the holes reserved on the second rod shell 3214. Moreover, the circuit board module 63 is electrically connected with the motor 21 and the battery 23 through the wires, and the wires between the circuit board module 63 and the motor 21 and the battery 23 are arranged along the inner space between the first rod shell 3213 and the second rod shell 3214, as well as the gap between the main body 101 and the shell cover 102.

As shown in FIG. 10 to FIG. 14, the embodiment of the present application provides another neck massager. Compared with the previous neck massager provided by the embodiment, the neck massager in the present embodiment is different in the following ways.

In the neck massager of the embodiment, as shown in FIG. 10 to FIG. 14, the contour shape of the casing 40 fits the contour shape of the main shell 10, so that the casing 40 and the main shell 10 are more fitted to realize the adaptive encapsulation of the main shell 10. The hell sleeve 40 includes a first elastic fabric 401 and a second elastic fabric 402. The edge of the first elastic fabric 401 is connected to the edge of the second elastic fabric 402, and the elasticity of the first elastic fabric 401 is greater than the elasticity of the second elastic fabric 402. Therefore, the second elastic fabric 402 can support the first elastic fabric 401, so that the overall contour shape of the casing 40 is an arc shape that fits the contour shape of the neck.

When the neck massager provided in the present application is assembled and produced, the main shell 10 and the massage assembly 20 are assembled into the main structure of the neck massager, and the main shell 10 and the massage assembly 20 are wrapped by the casing 40. Since the elasticity of the first elastic fabric 401 is greater than that of the second elastic fabric 402, that is, the material of the second elastic fabric 402 is harder than that of the first elastic fabric 401, therefore, when the main shell 10 is inserted into the casing 40 to tightly stretch the casing 40, as well as the massage head of the massage assembly 20 is moved, the second elastic fabric 402 can support the first elastic fabric 401. On the one hand, the overall contour shape of the casing 40 is curved to fit the contour shape of the neck. On the other hand, the first elastic fabric 401 is supported by the second elastic fabric 402, so as to reduce or even avoid the probability of the first elastic fabric 401 being rolled by the massage assembly 20 and folded together, so that the first elastic fabric 401 is tight and smoothly fit to the neck, so that the user always feels comfortable during the massage process, and the use experience of the user is better improved.

Furthermore, the edge of the first elastic fabric 401 and the edge of the second elastic fabric 402 can be connected by sewing, or by gluing, or by zipping, or by other means of connection, which is not limited herein.

The first elastic fabric 401 can be made of flexible soft flannel fabric, and the second elastic fabric 402 can be made of less elastic leather fabric. Thus, the casing 40 is divided into at least two regions with different elasticity, that is, the first elastic fabric 401 at least corresponds to a first elastic region, and the second elastic fabric 402 corresponds to a second elastic region. When the main shell 10 is inserted into the casing 40, at least part of the first elastic fabric 401 corresponds to the massage head 22 of the massage assembly 20, and the second elastic fabric 402 is fitted to the side of the main shell 10 away from the massage head 22, and when the user wears the neck massager, the part corresponding to the massage head 22 of the softer first elastic fabric 401 is fitted to the neck of the user, which makes more comfortable for the user to wear the neck massager.

As shown in FIG. 10 to FIG. 14, the width of the second elastic fabric 402 is arranged to expand from the middle to both ends. After the main shell 10 is inserted, the first elastic fabric 401 sewn on the second elastic fabric 402 can be more tightly fitted to the surface of the main shell 10 and corresponds to the massage head of the massage assembly 20. In this way, the problem of folding edges in the casing 40 is reduced, and even the folding edges are completely eliminated, so that the first elastic fabric 401 is more comfortable in contact with the neck surface of the user, and the use experience of the user is improved.

The latter neck massager provided in the embodiment of the present application is the same in structure as the former neck massager provided in the embodiment except for the above differences, which are not described here.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

1. A neck massager, comprising:
a main shell, with a contour shape being arranged to fit with a neck, wherein the main shell is provided with an assembly chamber;
a massage assembly, mounted in the assembly chamber and configured for massaging the neck;
a casing, wherein at least one end of the casing is provided with an opening, the main shell is inserted into the casing from the opening, and an end of the main shell corresponding to the opening is provide with an assembly position, and a circumferential edge of the opening is gathered to the assembly position; and
a first pressing member, mounted at the main shell, and the circumferential edge of the opening is clamped between the first pressing member and the assembly position.

2. The neck massager according to claim 1, wherein two ends of the casing are respectively provided with the opening, and two ends of the main shell are respectively provided with the assembly position; the neck massager further comprises a second pressing member connected to the other end of the main shell, the circumferential edge of one of the openings is clamped between the first pressing member and one of the assembly positions, and the circumferential edge of the other one of the openings is clamped between the second pressing member and the other one of the assembly positions.

3. The neck massager according to claim 1, wherein an end of the casing is provided with the opening, the other end of the casing is arranged to be a closed end, and two ends of the main shell are respectively provided with the assembly position; the neck massager further comprises a second pressing member connected to the other end of the main shell, the circumferential edge of the opening is clamped between the first pressing member and one of the assembly positions, and the closed end is clamped between the second pressing member and the other one of the assembly positions.

4. The neck massager according to claim 2, further comprises two clamping arm assemblies, one of the two clamping arm assemblies is connected to the first pressing member, the other one of the two clamping arm assemblies is connected to the second pressing member, and the two clamping arm assemblies are configured for jointly clamping on the neck.

5. The neck massager according to claim 4, wherein each of the two clamping arm assemblies comprises a mounting structure and a swinging arm structure, one end of the swinging arm structure is rotated and mounted at the end of the main shell through the mounting structure, and the mounting structure provides a clamping force to the swinging arm structure such that the other end of the swinging arm structure clamps the neck.

6. The neck massager according to claim 5, wherein the mounting structure comprises a mounting seat, a torsion spring and a pin shaft; the mounting seat is fixed at the end of the main shell, one end of the swinging arm structure is rotationally connected to the mounting seat through the pin shaft, the torsion spring is sleeved on the pin shaft, one end of the torsion spring is abutted against the mounting seat, and the other end of the torsion spring is abutted against one end of the swinging arm structure, so as to provide the clamping force.

7. The neck massager according to claim 5, wherein the swinging arm structure comprises an arm rod and a supporting portion, a first end of the arm rod is connected to the mounting structure, and the supporting portion is rotated and mounted at a second end of the arm rod.

8. The neck massager according to claim 7, wherein the swinging arm structure further comprises a ball member, the ball member is provided with rotatable balls, the ball member is mounted on the supporting portion; a side of the second end of the arm rod facing the supporting portion is provided with a rolling rail, the balls of the ball member are arranged on the rolling rail and rotate along the rolling rail.

9. The neck massager according to claim 8, wherein the rolling rail is formed with a plurality of ball sockets arranged at intervals along a groove track path, and the balls of the ball member are capable of inlaying and positioning in the ball sockets.

10. The neck massager according to claim 7, wherein each of the two clamping arm assemblies further comprises a supporting casing, the supporting portion comprises a first shell body and a second shell body, the supporting casing wraps around the second shell body, the first shell body covers on the second shell body, the first shell body and the second shell body are configured to clamp and fix an edge of a casing opening of the supporting casing, and the first shell body is rotated and mounted at the second end of the arm rod.

11. The neck massager according to claim 1, wherein a contour shape of the casing is matched with the contour shape of the main shell, the casing comprises a first elastic fabric and a second elastic fabric, an edge of the first elastic fabric is connected to an edge of the second elastic fabric, and an elasticity of the first elastic fabric is greater than that of the second elastic fabric.

12. The neck massager according to claim 11, wherein a width of the second elastic fabric is arranged to increase from a middle to two ends.

13. The neck massager according to claim 11, wherein at least a portion of the first elastic fabric corresponds to the massage assembly and is attached to the neck.

14. The neck massager according to claim 3, further comprises two clamping arm assemblies, one of the two clamping arm assemblies is connected to the first pressing member, the other one of the two clamping arm assemblies is connected to the second pressing member, and the two clamping arm assemblies are configured for jointly clamping on the neck.

15. The neck massager according to claim 2, wherein a contour shape of the casing is matched with the contour shape of the main shell, the casing comprises a first elastic fabric and a second elastic fabric, an edge of the first elastic fabric is connected to an edge of the second elastic fabric, and an elasticity of the first elastic fabric is greater than that of the second elastic fabric.

16. The neck massager according to claim 3, wherein a contour shape of the casing is matched with the contour shape of the main shell, the casing comprises a first elastic fabric and a second elastic fabric, an edge of the first elastic fabric is connected to an edge of the second elastic fabric, and an elasticity of the first elastic fabric is greater than that of the second elastic fabric.
